(19) United States
(12) Patent Application Publication
(10) Pub. No.: US 2012/0195053 A1
(43) Pub. Date: Aug. 2, 2012

(54) LED lamp

(76) Inventor: Wei Chung Wu, Taoyuan City (TW)

(21) Appl. No.: 13/068,405

(22) Filed: May 9, 2011

(30) Foreign Application Priority Data
Jan. 28, 2011 (TW) 100201977

(51) Int. Cl. F21V 29/00

(52) U.S. Cl. 362/373

(57) ABSTRACT

An LED lamp includes at least an LED unit, a heat-dissipating module, a substrate, a power module, a base, and a thermally insulating panel. The heat-dissipating module includes a plurality of cooling fins arranged radially, spaced apart from each other, and connected annularly. The LED unit is disposed on and coupled to the substrate. The substrate is disposed above the heat-dissipating module. The base is a hollow casing for accommodating the power module and the thermally insulating panel, and is coupled to the heat-dissipating module. The thermally insulating panel is inserted into a groove disposed on an inner edge of the base and positioned between the heat-dissipating module and the power module. The thermally insulating panel is spaced apart from the heat-dissipating module by an air-filled gap of a preset distance to insulate the heat generated by the LED unit and further protect the power module.

### BACKGROUND OF THE INVENTION

1. Field of the Invention

The present invention relates to light-emitting diode (LED) lamps, and more particularly, to an LED lamp which has a light-emitting diode (LED), a base, a power module disposed in the base, a thermally insulating panel, a heat-dissipating module, and a preset gap between the thermally insulating panel and the heat-dissipating module, so as to further insulate the heat generated by the LED and prevent the power module from being overheated.

2. Description of the Prior Art

Among a wide variety of commercially available lamps, incandescent lamps always account for a constantly large market share. Conventional incandescent lamps are power-consuming, highly heat-generating, and relatively short-lived. Not only do conventional incandescent lamps become environment-unfriendly in the present era of high-priced electricity supply, but the highly heat-generating conventional incandescent lamps are likely to end up with an accident, such as a fire caused by a short circuit. In view of this, innovative novel products were launched into the lighting equipment market in recent years. For example, projector lamps which use an LED as a major light source substitute for conventional incandescent lamps.

Conventional LED lamps are likely to generate high heat and thus are usually equipped with a plurality of cooling fins for preventing the LED lamps from being overheated. Referring to FIG. 1, there is shown a schematic cross-sectional view of a conventional LED lamp 1. As shown in the drawing, the conventional LED lamp 1 essentially comprises an LED unit 11, a heat-dissipating module 12, a central post 13, a control circuit 14, and a base 15. The LED unit 11 is disposed at one end of the heat-dissipating module 12. The heat-dissipating module 12 comprises a plurality of cooling fins 121 which enclose the central post 13. The other end of the heat-dissipating module 12 is coupled to the base 15. The control circuit 14 is disposed at the hollow core of the central post 13 and electrically connected to the LED unit 11 and the base 15.

Although the conventional LED lamp 1 is more power-saving and environment-friendly than conventional incandescent lamps, the LED unit 11 is also confronted with a problem with heat dissipation. This is particularly true of the LED unit 11 that generates plenty of heat while operating, and thus the LED unit 11 has to dissipate heat quickly through the heat-dissipating module 12. Furthermore, the control circuit 14 is disposed centrally in the heat-dissipating module 12, and thus the control circuit 14 is exposed to the high heat spread from the heat-dissipating module 12; as a result, the control circuit 14 has to operate at high temperature. When operating for a long period of time, the control circuit 14 is likely to be compromised by the aging of components, such as electrolytic capacitors and integrated circuits (IC), which eventually causes damage to the components of the control circuit 14; as a result, the LED lamp 1 disadvantageously features a great increase in its failure rate and non-conforming rate and even a reduction in its service life.

In view of this, the present invention aims to address related issues, namely insulating the heat generated by the LED unit 11 from the control circuit 14, reducing the likelihood of a short circuit occurring to the control circuit 14, and extending the service life of the LED lamp 1.

### SUMMARY OF INVENTION

Accordingly, it is a primary objective of the present invention to provide an LED lamp having an LED, a power module, and a thermally insulating panel for insulating the heat generated by the LED from the power module, so as to extend the service life of the power module.

Another objective of the present invention is to provide an LED lamp having cooling fins each bending at a preset position thereof in a first direction and thereby bending at a preset included angle, and an elongate curved bend is disposed at a preset peripheral position of the plate-shaped cooling fin, to thereby reinforce the cooling fins and increase the heat-dissipating area of the cooling fins while still meeting the requirement of a uniform outer diameter.

Yet another objective of the present invention is to provide an LED lamp, such that a heat conduction medium increasing a heat transfer rate can be applied to an engaging surface of a substrate and an engaging surface of a carrying board, wherein the engaging surface of the substrate enables the substrate to engage with a carrying board, and the engaging surface of the carrying board enables the carrying board to engage with connecting portions of the cooling fins.

In order to achieve the aforementioned objective, the present invention discloses an LED lamp which comprises:

at least an LED unit;

a central post being a pipe structure made of metal and hollowed out to have two ends in communication with each other, the central post comprising a top end, a bottom end, and a through hole;

a heat-dissipating module comprising a plurality of cooling fins positioned proximate to a periphery of the central post, arranged radially, spaced apart from each other, and connected annularly, the cooling fins having connecting portions bending in a first direction to connect to each other, wherein, from a point where the cooling fins each meet the top end of the central post, the connecting portions each extend outward and then upward for a preset distance to form a lower step sharing a common axis with the central post;

a carrying board disposed above the connecting portion and centrally disposed with an opening in communication with the through hole of the central post;

a substrate disposed on the carrying board, wherein the LED unit is disposed on and coupled to the substrate;

a power module comprising a circuit loop and being electrically connected to the LED unit coupled to the substrate through the through hole of the central post;

a base provided in form of a hollow casing, adapted to receive the power module, and coupled to a hook beneath the heat-dissipating module; and

a thermally insulating panel inserted into a groove disposed on an inner edge of the base, positioned between the heat-dissipating module and the power module, and disposed with a via in communication with the through hole, thereby allowing the power module to be electrically connected to the LED unit by means of a wire passing through the via.

wherein, the thermally insulating panel is spaced apart from the heat-dissipating module by a gap of a preset distance.

In a preferred embodiment, the LED lamp further comprises an annular protective cover disposed above the heat-dissipating module, centrally disposed with a cavity corresponding in position to the lower step, and adapted to encase and enclose a periphery of each of the cooling fins. Such that, the annular protective cover is firmly coupled to the heat-dissipating module, and a peripheral margin of each of the cooling fins doubles back from a preset position thereof and extends toward the lower step to form an elongate curved bend.

In a preferred embodiment, the base is laterally provided with an electrically conductive thread for electrical connection to the power module.

In a preferred embodiment, the LED lamp further comprises at least a pin penetratingly disposed in the base and electrically connected to the power module.

In a preferred embodiment:

a heat conduction medium is applied to engaging surfaces of the substrate and the carrying board and engaging surfaces of the carrying board and the connecting portion, wherein the heat conduction medium is one of a solder paste, a heat conductive grease, and a heat conductive glue;

the substrate is one of a ceramic substrate, a FR4 substrate, and a metal substrate; and

the carrying board is made of a highly thermally conductive metal, such as iron, copper, aluminum, silver, gold, or one whose surface is electroplated with a metal, and the central post is made of iron, copper, aluminum, silver, or gold, or an alloy thereof.

In a preferred embodiment, the cooling fins each bend at a preset position thereof in the first direction, such that the cooling fins each form a preset included angle ranging between 100° and 170°.

### BRIEF DESCRIPTION OF THE DRAWINGS

The present invention will now be specified with reference to its preferred embodiment illustrated in the drawings, in which:

FIG. 1 is a schematic cross-sectional view of a conventional LED lamp;

FIG. 2 is an exploded perspective view of an LED lamp according to a first preferred embodiment of the present invention;

FIG. 3 is an assembled perspective view of the LED lamp according to the first preferred embodiment of the present invention;

FIG. 4 is a schematic cross-sectional view of the LED lamp according to the first preferred embodiment of the present invention;

FIG. 5 is an assembled perspective view of the LED lamp according to a second preferred embodiment of the present invention;

FIG. 6 is an exploded perspective view of an LED lamp according to a third preferred embodiment of the present invention;

FIG. 7 is a schematic cross-sectional view of the LED lamp according to the third preferred embodiment of the present invention;

FIG. 8 is a schematic top view of a heat-dissipating module for use with the LED lamp according to the third preferred embodiment of the present invention;

FIG. 9 is a schematic top view of cooling fins for use with the LED lamp according to the third preferred embodiment of the present invention; and

FIG. 10 is a front view of the cooling fins for use with the LED lamp according to the third preferred embodiment of the present invention.

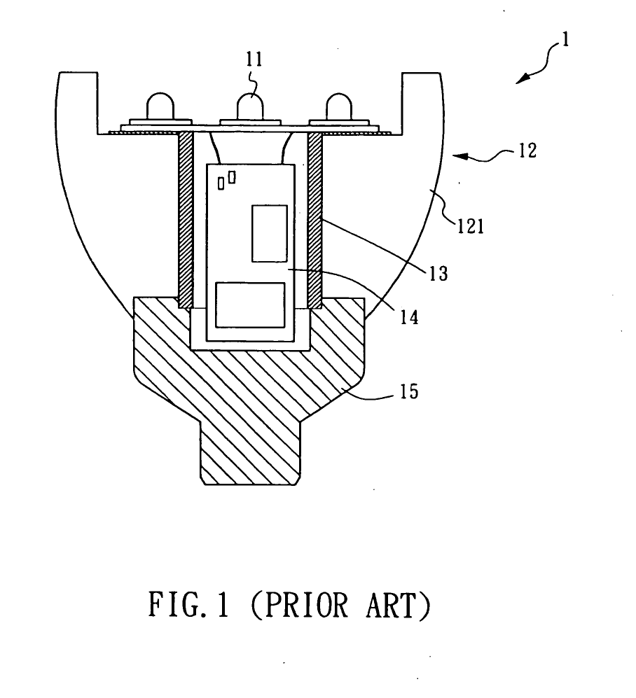

### DESCRIPTION OF THE PREFERRED EMBODIMENT

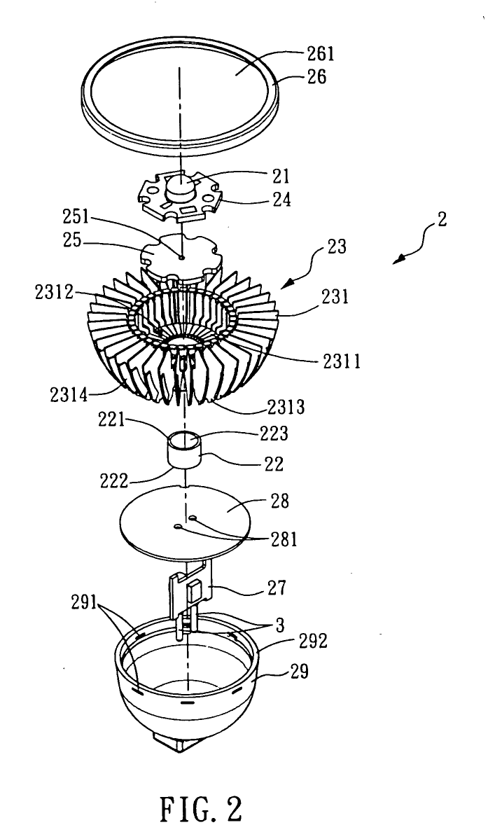

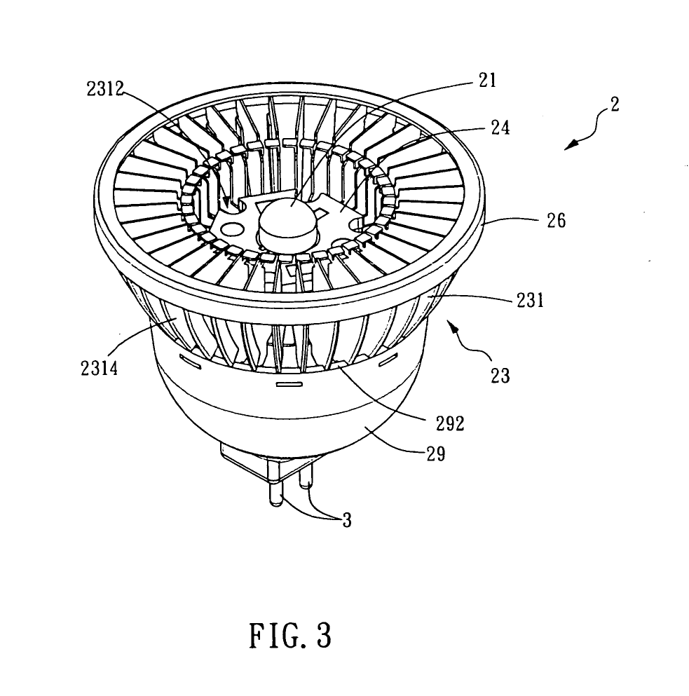

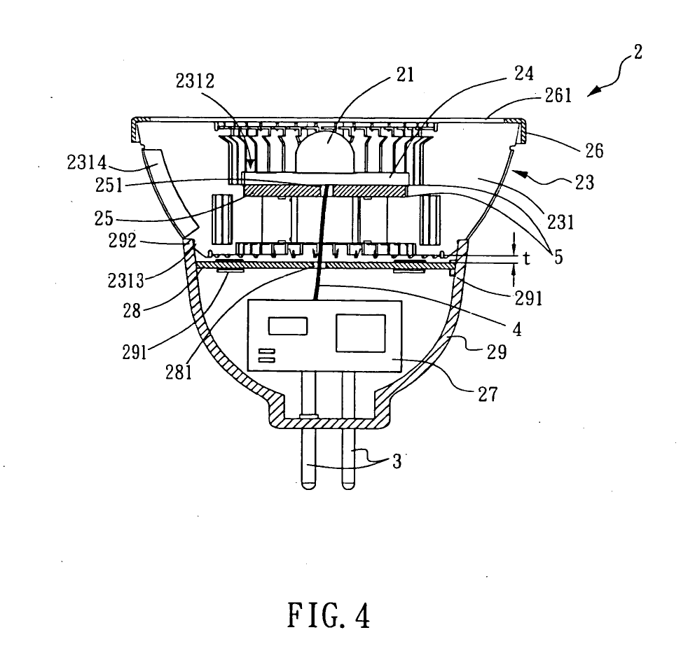

Referring to FIG. 2, FIG. 3 and FIG. 4, there are shown an exploded perspective view, an assembled perspective view, and a schematic cross-sectional view of an LED lamp 2 according to a first preferred embodiment of the present invention, respectively. As shown in FIG. 2, the

LED lamp 2 of the present invention comprises: at least an LED unit 21, a central post 22, a heat-dissipating module 23, a substrate 24, a carrying board 25, an annular protective cover 26, a power module 27, a thermally insulating panel 28, and a base 29.

The central post 22 is a pipe structure made of metal and hollowed out to have two ends in communication with each other. The central post 22 comprises a top end 221, a bottom end 222, and a through hole 223. The central post 22 is made of a highly thermally conductive metal, such as iron, copper, aluminum, silver, or gold, or an alloy thereof.

The heat-dissipating module 23 comprises a plurality of cooling fins 231 made of metal, arranged radially, spaced apart from each other, and connected annularly in a manner that the plurality of cooling fins 231 is positioned at the periphery of the central post 22. First connecting portions 2311 of the cooling fins 231 bend in the first direction (perpendicular to the centrally disposed axis of the central post 22) and connect to each other. From a point where the cooling fin 231 meets the top end 221 of the central post 22, the connecting portion 2311 extends outward and then upward for a preset distance to form a lower step 2312 sharing a common axis with the central post 22. A hook 2313 is disposed from beneath each of the cooling fins 231.

A peripheral margin of each of the cooling fins 231 doubles back from a preset position thereof and extends toward the lower step 2312 to form an elongate curved bend 2314. The curved bend 2314 substantially reaches an appropriate point beneath the heat-dissipating module 23 to not only allow a convenient and safe user's grip thereon but also reinforce the cooling fins 231. The heat-dissipating area of the cooling fins 231 increases, because not only the curved bend 2314 is substantially curved and has a pleat 2 mm to 6 mm long but a pleated portion of the curved bend 2314 is not attached to the surface of the cooling fins 231. The cooling fins 231 of the heat-dissipating module 23 are made of a highly thermally conductive metal, such as iron, copper, aluminum, silver, nickel, or gold, or an alloy thereof.

The LED unit 21 is disposed on and coupled to the substrate 24. The substrate 24 is disposed above the carrying board 25. A plurality of passive components or simple circuits are disposed on the substrate 24 and connected to a power supply required for the LED unit 21 to emit light. Heat generated by the LED unit 21 when emitting light is transferred to the cooling fins 231 and dissipated to the surroundings, using the substrate 24 and the carrying board 25. In this embodiment, the substrate 24 is a metal substrate, a ceramic substrate, or a FR4 substrate, which is good at heat conduction. In this embodiment, the substrate 24 is one of a ceramic substrate, a FR4 substrate, and a metal substrate (such as an aluminum substrate or a copper substrate).

The carrying board 25 is centrally disposed with an opening 251 in communication with the through hole 223 disposed centrally in the central post 22, and is further disposed in the lower step 2312 formed centrally in the heat-dissipating module 23. The substrate 24 is disposed on and coupled to the carrying board 25, such that the heat generated by the LED unit 21 is transferred to the cooling fins 231 through the carrying board 25. Hence, the heat generated by the LED unit 21 disposed on the substrate 24 is quickly transferred to the cooling fins 231through contact with the connecting portion 2311 from below. The carrying board 25 is made of a highly thermally conductive metal, such as iron, copper, aluminum, silver, gold, or one whose surface is electroplated with a metal. A heat conduction medium 5 for increasing a heat transfer rate is applied to engaging surfaces of the substrate 24 and the carrying board 25 and engaging surfaces of the carrying board 25 and the connecting portion 2311. The heat conduction medium 5 is one of a solder paste, a heat conductive grease, and a heat conductive glue. The effect of heat conduction and heat dissipation is optimal when the solder paste, rather than the heat conductive grease or the heat conductive glue, is used as the heat conduction medium 5 in soldering the carrying board 25 to the connecting portion 2311.

The annular protective cover 26 is disposed on the heat-dissipating module 23. A cavity 261 is disposed centrally at the annular protective cover 26 to correspond in position to the lower step 2312. The annular protective cover 26 encases and encloses a top periphery of each of the cooling fins 231. The annular protective cover 26 is firmly coupled to the heat-dissipating module 23. The power module 27 comprises a circuit loop disposed in the base 29. The thermally insulating panel 28 which is made of a non-metal good at thermal insulation includes, but is not limited to, a heat-resistant plastic plate, a ceramic plate, a glass plate, or a mica sheet. The thermally insulating panel 28 is disposed with at least a via 281 from above, inserted into a groove 291 disposed on an inner edge of the base 29, and positioned between the bottom of the heat-dissipating module 23 and the power module 27. In the first preferred embodiment of the present invention, a plurality of grooves 291 spaced apart from each other is circumferentially disposed at an inner edge of the base 29 for allowing the periphery of the thermally insulating panel 28 to be evenly inserted into the plurality of grooves 291. Also, the power module 27 is electrically connected to the LED unit 21 coupled to the substrate 24, using a wire 4 that passes through the via 281 of the thermally insulating panel 28 and the through hole 223 disposed centrally in the central post 22 to penetrate the opening 251 of the carrying board 25.

The base 29 is a hollow casing for accommodating the power module 27 and the thermally insulating panel 28. The base 29 is coupled, by means of a fringe 292 thereof, to the hook 2313 beneath the heat-dissipating module 23. The LED lamp 2 further comprises at least a pin 3. The pin 3 is penetratingly disposed in the base 29 and electrically connected to the power module 27. In the first preferred embodiment of the present invention, two pins 3 which are arranged in pairs extend from below the base 29 to function as a medium whereby the power module 27 is connected to an external power source.

As shown in FIG. 4, the LED lamp 2 of the present invention is characterized in that the thermally insulating panel 28 is spaced apart from the heat-dissipating module 23 by a preset distance T for insulating the heat generated by the LED unit 21 to protect the power module 27. Air is present in a gap of a preset distance T between the thermally insulating panel 28 and the bottom of the heat-dissipating module 23 serves to insulate the thermally insulating panel 28 and the heat-dissipating module 23 from each other. Furthermore, the air present in the gap and ambient air exchange heat by convection, thereby enhancing heat dissipation. The thermally insulating panel 28 is made of an insulating non-metal with an extremely low thermal conductivity. Hence, for all the above reasons, the power module 27 disposed inside the base 29 can be better protected against the heat generated by the LED unit 21 in operation, so as to extend the service life of the power module 27 greatly and enhance the stability of the use of the LED lamp 2. The preset distance T between the thermally insulating panel 28 and the heat-dissipating module 23 ranges between 2 mm and 6 mm.

Furthermore, the LED lamp 2 of the present invention meets a specification selected from the group consisting of MR-16, A-Bulb, AR111, PAR-20, PAR30, PAR38, GU-10, E11, and E17. The LED lamp 2 is applicable to a light-emitting carrier selected from the group consisting of ceiling light, bay light, desk light, streetlight, searchlight, projection light, hand-held lamp, light bulb, and down light.

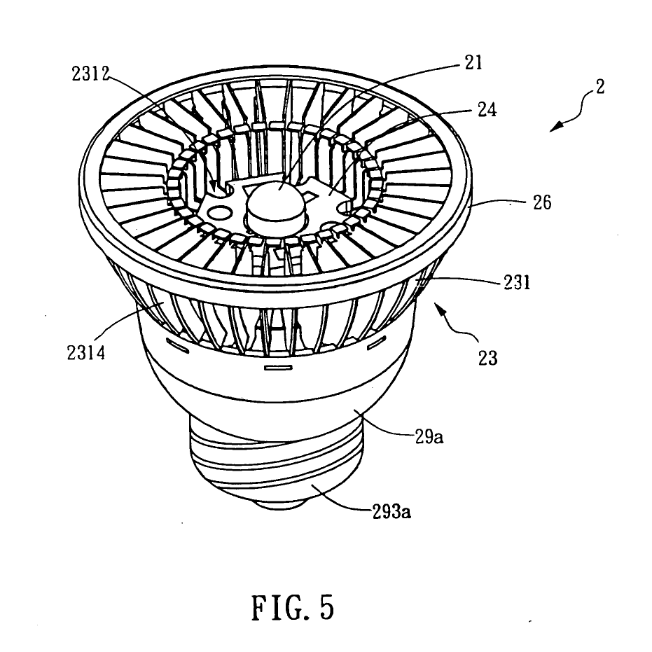

Referring to FIG. 5, there is shown an assembled perspective view of the LED lamp according to a second preferred embodiment of the present invention. As shown in FIG. 5, the LED lamp of the second preferred embodiment of the present invention is different from that of the first preferred embodiment of the present invention in that, in the second preferred embodiment of the present invention, the base 29a is laterally provided with an electrically conductive thread 293a for electrical connection to the power module 27. In the second preferred embodiment of the present invention, the electrically conductive thread 293a of the base 29a is configured to comply with the specifications of metallic swivel adapters of common conventional incandescent lamps, namely E11, E12, E14, E17, E26, E27, E40. The numeral behind the letter “E” denotes the diameter of the electrically conductive thread 293a. For example, household lamps usually fall within the E27 category, and thus the thread diameter of the metallic swivel adapters for use with the lamps is 27 mm (i.e., 2.7 cm).

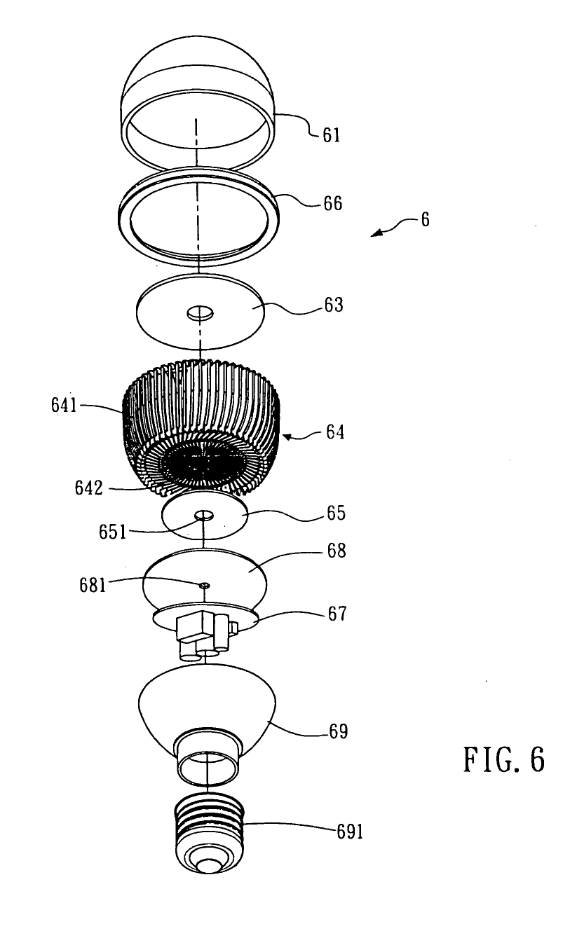

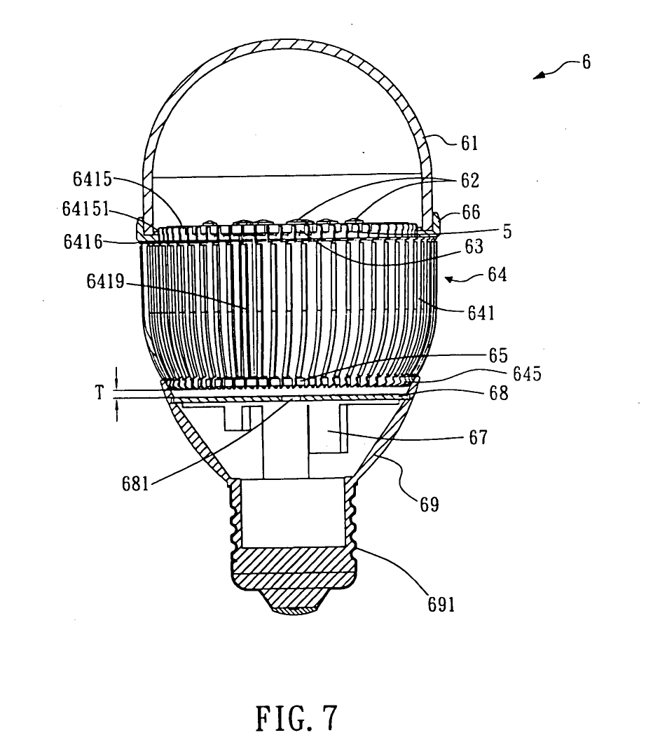

Referring to FIG. 6 and FIG. 7, there are shown an exploded perspective view and a schematic cross-sectional view of an LED lamp 6 according to a third preferred embodiment of the present invention, respectively. As shown in FIG. 6 and FIG. 7, the LED lamp 6 according to the third preferred embodiment of the present invention comprises a lampshade 61, at least an LED unit 62, a substrate 63, a heat-dissipating module 64, a fixing element 65, an annular protective cover 66, a power module 67, a thermally insulating panel 68, and a base 69.

In this embodiment, the substrate 63 essentially comprises a silver wiring formed by sintering a ceramic plate. At least an LED unit 62 is disposed on the substrate 63 and electrically connected to the silver wiring. The heat-dissipating module 64 comprises a plurality of cooling fins 641 arranged radially, spaced apart from each other, and connected annularly. The heat-dissipating module 64 is coupled to the substrate 63. A hollow core 642 is formed centrally in the heat-dissipating module 64.

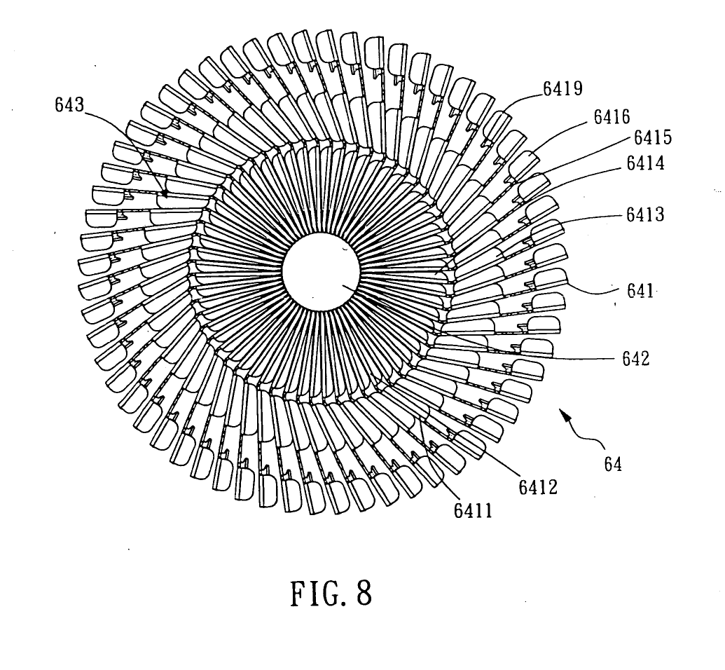

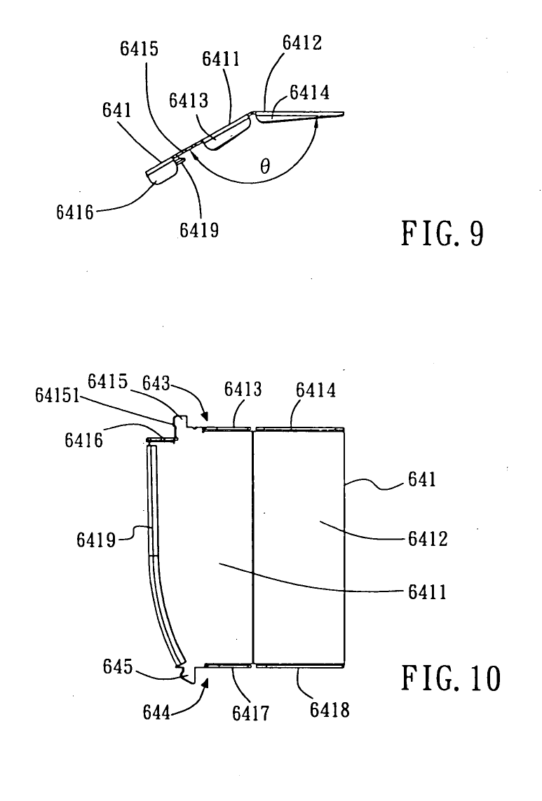

Referring to FIG. 8, FIG. 9 and FIG. 10, there are shown a top view of a heat-dissipating module for use with the LED lamp according to, the third preferred embodiment of the present invention, and a top view and a front view of the cooling fins for use with the LED lamp according to the third preferred embodiment of the present invention, respectively. As shown in FIG. 8, FIG. 9 and FIG. 10, the cooling fins 641 each bend at a preset position thereof and in a first direction. The cooling fins 641 of the heat-dissipating module 64 each further comprise a first flap 6411 and a second flap 6412. The first flap 6411 and the second flap 6412 together form a preset included angle 0 therebetween. The included angle 0 of the cooling fins 641 preferably ranges between 100° and 170°.

A first connecting portion 6413 and a second connecting portion 6414, which bend in the first direction, are disposed at preset positions on upper edges of the first flap 6411 and the second flap 6412 of the cooling fins 641, respectively. A step-like extending portion 6415 and a carrying portion 6416 bending in the first direction are disposed on the upper edges of the first flap 6411. An outward-facing hook 64151 is disposed at a top end of the extending portion 6415. A first lower step 643 is formed above the heat-dissipating module 64 and defined by the extending portion 6415 relative to the first connecting portion 6413 and the second connecting portion 6414. The first lower step 643 enables the heat-dissipating module 64 to be coupled to the substrate 63. A second lower step 644 with an inward profile is disposed at the lower edge of each of the cooling fins 641 and oriented in a direction opposite to the first lower step 643. A third connecting portion 6417 and a fourth connecting portion 6418 which correspond in position to the first connecting portion 6413 and the second connecting portion 6414, respectively, are disposed on the inner side of the second lower step 644.

With the cooling fins 641 each bending at the included angle 0, the first connecting portion 6413 and the second connecting portion 6414 together function as a bottom side of the first lower step 643, such that the substrate 63 and the LED unit 62 are mounted on the bottom side of the first lower step 643. Likewise, the third connecting portion 6417 and the fourth connecting portion 6418 together function as a bottom side of the second lower step 644, such that the fixing element 65 is mounted on the bottom side of the third connecting portion 6417 and the fourth connecting portion 6418. An opening 651, which is disposed centrally at the fixing element 65, communicates with the hollow core 642 and thereby provides a passage required for the electrical connection between the power module 67 and the substrate 63.

In this embodiment, the fixing element 65, which is a plate, is affixed to the bottom side of the second lower step 644 by means of a heat-resistant glue; in other words, the fixing element 65 is affixed to the third connecting portion 6417 and the fourth connecting portion 6418 and thereby configured to fix the cooling fins 641 in place and reinforce the cooling fins 641. In another embodiment not shown, the fixing element 65 can also be a ring affixed to the hollow core 642 of the heat-dissipating module 64 by means of a heat-resistant glue. The fixing element 65 is made of one of a bakelite sheet, metal, and plastic.

The annular protective cover 66 is ring-shaped and is of an L-shaped cross-section. The annular protective cover 66 is engaged with the hook 64151 of the extending portion 6415 and coupled to the carrying portion 6416 in a manner to encase and enclose a periphery of each of the cooling fins 641. In this embodiment, the annular protective cover 66 is made of metal or plastics and is glued to the carrying portion 6416 by means of an adhesive (including, but not limited to, an acrylic resin). The lampshade 61, which is a transparent or translucent cover body, is coupled to the annular protective cover 66 and adapted to cover the substrate 63 from above. A peripheral margin of the cooling fins 641 doubles back from a preset position thereof and extends toward the first lower step 643 to form an elongate curved bend 6419. The curved bend 6419 has a pleat 2 mm to 6 mm wide substantially, such that a pleated portion of the curved bend 6419 is not attached to a surface of the first flap 6411, thereby further increasing the heat-dissipating surface area of the cooling fins 641.

The power module 67 comprises a circuit loop. The power module 67 is disposed inside the base 69. The power module 67 is electrically connected to the LED unit 62 coupled to the substrate 63 through the hollow core 642. The thermally insulating panel 68 is inserted into the base 69 and positioned between the heat-dissipating module 64 and the power module 67. The thermally insulating panel 68 is spaced apart from the heat-dissipating module 64 by a gap of a preset distance T. The preset distance T between the thermally insulating panel 68 and the heat-dissipating module 64 ranges between 2 mm and 6 mm. A via 681 which is disposed centrally in the thermally insulating panel 68 communicates with the hollow core 642 and the opening 651 and thereby provides a passage required for the electrical connection between the power module 67 and the substrate 63. The base 69 is a hollow casing and is coupled to a hook 645 beneath the heat-dissipating module 64. The base 69 is laterally provided with an electrically conductive thread 691 for electrical connection to the power module 67.

The heat conduction medium 5 can be applied to engaging surfaces of the substrate 63 for increasing a heat transfer rate, wherein the engaging surfaces of the substrate 63 enable the substrate 63 to engage with the first connecting portion 6413 and the second connecting portion 6414, respectively. Similarly, the heat conduction medium 5 in this embodiment can be the same solder paste used as the heat conduction medium 5 in the first preferred embodiment to provide optimal effect of heat conduction and heat dissipation.

From the perspective of the downward direction shown in FIG. 8 and FIG. 9, the cooling fins 641 each bend at a preset position and in the first direction, such that a preset included angle 0 is formed between the first flap 6411 and the second flap 6412 of each of the cooling fins 641. Likewise, the cooling fins 641 are arranged radially, spaced apart from each other, and connected annularly in a manner to form the heat-dissipating module 64. Accordingly, not only is it feasible to increase the surface area (i.e., the heat-dissipating area) of the cooling fins 641 on the premise that the outer diameter thereof is uniform, but the overall heat-dissipating efficiency of the heat-dissipating module 64 of the LED lamp 6 is enhanced.

The triangle inequality theorem states that, for any triangle, the sum of the lengths of any two sides must be greater than the length of the remaining side. Applying the theorem to an LED lamp in the third preferred embodiment of the present invention and keeping uniform the outer diameter of the LED lamp 6 can bring about a dimensional feature of the cooling fins 641 in the third preferred embodiment, that is, bending the cooling fins 641 in the third embodiment increases the surface area thereof and thereby increases the heat-dissipating area of the heat-dissipating module 64 in its entirety, when compared with the unbent cooling fins 231 in the first preferred embodiment. Hence, the cooling fins 641 thus bent can dissipate the heat generated by the LED unit 62 to the surroundings quickly through the cooling fins 641 of an enlarged surface area, so as to enhance the heat-dissipating efficiency of the LED lamp 6 while still meeting the requirement of a constant outer diameter (because commercially available indoor lamps usually have their respective standardized specifications regarding dimensions, such as an outer diameter), speed up the temperature dropping process of the LED lamp 6, and extend the service life of the LED lamp 6.

While the present invention has been particularly shown and described with reference to a preferred embodiment, it will be understood by those skilled in the art that various changes in form and detail may be without departing from the spirit and scope of the present invention.

What is claimed is:

1. An LED lamp, comprising:
at least an LED unit;
a central post being a pipe structure made of metal and hollowed out to have two ends in communication with each other, the central post comprising a top end, a bottom end, and a through hole;
a heat-dissipating module comprising a plurality of cooling fins positioned proximate to a periphery of the central post, arranged radially, spaced apart from each other, and connected annularly, the cooling fins having connecting portions bending in a first direction to connect to each other, wherein, from a point where the cooling fins each meet the top end of the central post, the connecting portions each extend outward and then upward for a preset distance to form a lower step sharing a common axis with the central post;
a carrying board disposed above the connecting portion and centrally disposed with an opening in communication with the through hole of the central post;
a substrate disposed on the carrying board, wherein the LED unit is disposed on and coupled to the substrate;
a power module comprising a circuit loop and being electrically connected to the LED unit coupled to the substrate through the through hole of the central post;
a base provided in form of a hollow casing, adapted to receive the power module, and coupled to a hook beneath the heat-dissipating module; and
a thermally insulating panel inserted into a groove disposed on an inner edge of the base, positioned between the heat-dissipating module and the power module, and disposed with a via in communication with the through hole, thereby allowing the power module to be electrically connected to the LED unit by means of a wire passing through the via.
wherein, the thermally insulating panel is spaced apart from the heat-dissipating module by a gap of a preset distance.

2. The LED lamp of claim 1, further comprising an annular protective cover disposed above the heat-dissipating module, centrally disposed with a cavity corresponding in position to the lower step, and adapted to encase and enclose a periphery of each of the cooling fins, such that the annular protective cover is firmly coupled to the heat-dissipating module, and a peripheral margin of each of the cooling fins doubles back from a preset position thereof and extends toward the lower step to form an elongate curved bend.

3. The LED lamp of claim 1, wherein the base is laterally provided with an electrically conductive thread for electrical connection to the power module.

4. The LED lamp of claim 1, further comprising at least a pin penetratingly disposed in the base and electrically connected to the power module.

5. The LED lamp of claim 1, wherein:
a heat conduction medium is applied to engaging surfaces of the substrate and the carrying board and engaging surfaces of the carrying board and the connecting portion, wherein the heat conduction medium is one of a solder paste, a heat conductive grease, and a heat conductive glue;
the substrate is one of a ceramic substrate, a FR4 substrate, and a metal substrate; and
the carrying board is made of a highly thermally conductive metal, such as iron, copper, aluminum, silver, gold, or one whose surface is electroplated with a metal, and the central post is made of iron, copper, aluminum, silver, or gold, or an alloy thereof.

6. The LED lamp of claim 1, wherein the cooling fins each bend at a preset position thereof in the first direction, such that the cooling fins each form a preset included angle ranging between 100° and 170°.

7. An LED lamp, comprising:
a substrate with at least an LED unit thereon;
a heat-dissipating module beneath the substrate;
a base provided in form of a hollow casing and coupled to the heat-dissipating module from beneath;
a power module comprising a circuit loop, wherein the power module is received in the base and electrically connected to the at least an LED unit coupled to the substrate; and
a thermally insulating panel inserted into the base and positioned between the heat-dissipating module and the power module, wherein the thermally insulating panel has a via and is spaced apart from the heat-dissipating module by a gap of a preset distance.

8. The LED lamp of claim 7, wherein the LED lamp further comprises a central post, a carrying board, and an annular protective cover, and is characterized in that:
the central post is disposed beneath the substrate and comprises a top end, a bottom end, and a through hole;
the power module is received in the base and electrically connected to the at least an LED unit coupled to the substrate through the through hole of the central post;
the base is coupled to a hook beneath the heat-dissipating module;
the heat-dissipating module comprises a plurality of cooling fins positioned proximate to a periphery of the central post, arranged radially, spaced apart from each other, and connected annularly, and the cooling fins have connecting portions bending in a first direction to connect to each other, wherein, from a point where the cooling fins each meet the top end of the central post, the connecting portions each extend outward and then upward for a preset distance to form a lower step sharing a common axis with the central post;
the carrying board is disposed above the connecting portion and centrally disposed with an opening in communication with the through hole, and the substrate is disposed on the carrying board;
the annular protective cover is disposed above the heat-dissipating module and adapted to encase and enclose a periphery of each of the cooling fins; and
the cooling fins each bend at a preset position thereof in the first direction, such that the cooling fins each form a preset included angle, wherein the included angle of the cooling fins ranges between 100° and 170°, wherein a peripheral margin of each of the cooling fins doubles back from a preset position thereof and extends toward the lower step to form an elongate curved bend in a manner that the curved bend has a pleat 2 mm to 6 mm wide substantially, such that a pleated portion of the curved bend is not attached to a surface of the cooling fins.

9. The LED lamp of claim 8, wherein:
a heat conduction medium is applied to engaging surfaces of the substrate and the carrying board and engaging surfaces of the carrying board and the connecting portion, wherein the heat conduction medium is one of a solder paste, a heat conductive grease, and a heat conductive glue;
the substrate is one of a ceramic substrate, a FR4 substrate, and a metal substrate; and
the carrying board is made of a highly thermally conductive metal, such as iron, copper, aluminum, silver, gold, or one whose surface is electroplated with a metal, and the central post is made of iron, copper, aluminum, silver, or gold, or an alloy thereof.

10. The LED lamp of claim 7, further comprising a fixing element and an annular protective cover, characterized in that:
the heat-dissipating module comprises a plurality of cooling fins arranged radially, spaced apart from each other, and connected annularly to form the heat-dissipating module, and has a hollow core centrally formed therein, wherein the substrate is coupled to a bottom side of a first lower step of the heat-dissipating module;
the fixing element is coupled to a bottom side of a second lower step of the heat-dissipating module and centrally disposed with an opening in communication with the hollow core centrally disposed in the heat-dissipating module to thereby provide a passage required for electrical connection between the power module and the at least an LED unit coupled to the substrate;
the base is coupled to a hook beneath the heat-dissipating module;
the annular protective cover is disposed above the heat-dissipating module in a manner to encase and enclose a periphery of each of the cooling fins;
the cooling fins each bend at a preset position thereof in the first direction, such that the cooling fins each form a preset included angle ranging between 100° and 170°; and
a peripheral margin of each of the cooling fins doubles back from a preset position thereof and extends toward the lower step to form an elongate curved bend, and the curved bend has a pleat 2 mm to 6 mm wide substantially, such that a pleated portion of the curved bend is not attached to a surface of the cooling fins.
